(19) United States
(12) Patent Application Publication
(10) Pub. No.: US 2007/0291294 A1
(43) Pub. Date: Dec. 20, 2007

(54) PRINTING APPARATUS, PRINT CONTROL METHOD, PROGRAM, AND STORAGE MEDIUM

(75) Inventor: Wataru Suzuki, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/759,545

(22) Filed: Jun. 7, 2007

(30) Foreign Application Priority Data
Jun. 16, 2006 (JP) 2006-168115

(51) Int. Cl. G06F 3/12

(52) U.S. Cl. 358/1.13; 358/1.16

(57) ABSTRACT

Document data received via a network is analyzed to detect the presence/absence of external reference data to be acquired from a reference destination on the network, and a reference count of the external reference data. Based on the analysis result, external reference data is acquired from the reference destination on the network. The acquired external reference data is stored in a memory in a reusable state. When it is determined based on the reference count and the reuse count of the external reference data that the external reference data is not reused, the external reference data stored in the reusable state is deleted.

### BACKGROUND OF THE INVENTION

1. Field of the Invention

The present invention relates to a print technique for efficiently processing document data.

2. Description of the Related Art

Structured document data, for example, XML (extensible Markup Language) data as a typical standard, is described using specific character strings called “tags”, so that an information processing apparatus or the like can interpret and handle the semantic contents of the data.

Some printing apparatuses connected to a network have a direct print function that refers to structured document data from the storage location on a network designated by a URL (external reference), and directly interprets and prints that data in the printing apparatus. Upon printing structured document data by external reference, the printing apparatus also automatically acquires document data and the like at the external reference destination.

According to Japanese Patent Laid-Open No. 2002-091726, a printer system in which objects described in structured document data are external reference data such as URLs, file names, and the like, and which completes and prints document data by collecting objects based on the external reference data is proposed.

However, with the above printer system, upon printing structured document data that includes a plurality of data to be acquired from an identical external reference destination, data acquisition of identical contents is repeated, and acquired data are stored in the printer system. That is, in the conventional printer system, every time designation of an identical external reference is detected, loading, storage, and conversion of data of identical contents are redundantly executed, resulting in inefficient processing of document data.

The present invention has been made in consideration of the aforementioned problems, and has as its object to provide a print technique that can efficiently process document data including an external reference.

### SUMMARY OF THE INVENTION

According to one aspect of the present invention, an embodiment is directed to a printing apparatus comprising:

an analyzing unit adapted to analyze, from document data received via a network, a reference count of each of external reference data to be acquired from a reference destination on the network;

an acquiring unit adapted to acquire the external reference data from the reference destination on the network based on the analysis result of the analyzing unit;

an interpreting unit adapted to interpret the external reference data acquired by the acquiring unit;

a storage unit adapted to store the data interpreted by the interpreting unit in a reusable state; and

a management unit adapted to manage storage of the interpreted data in the storage unit based on the reference count.

According to another aspect of the present invention, an embodiment is directed to a printing control method comprising steps of:

analyzing, from document data received via a network, a reference count of each of external reference data to be acquired from a reference destination on the network;

acquiring the external reference data from the reference destination on the network based on the analysis result in the analyzing step;

interpreting the external reference data acquired in the acquiring step;

storing, in a storage unit, the external reference data interpreted in the interpreting step in a reusable state; and

managing storage of the interpreted data in the storage unit based on the reference count.

Further features of the present invention will become apparent from the following description of exemplary embodiments with reference to the attached drawings.

### BRIEF DESCRIPTION OF THE DRAWINGS

FIG. 1 is a block diagram for explaining the arrangement of a printing apparatus connected to a network according to one embodiment of the present invention;

FIG. 2 is a block diagram focused on the functional arrangement of a printer control unit according to the embodiment of the present invention;

FIG. 3 is a flowchart for explaining the procedure of basic processing of the printing apparatus according to the embodiment of the present invention;

FIG. 4 is a flowchart for explaining the procedure of processing of the printing apparatus when document data input to the printing apparatus according to the embodiment of the present invention is data including concepts for respective pages;

FIG. 5 is a flowchart for explaining the practical procedure of external reference data acquisition processing;

FIG. 6 is a flowchart for explaining an example when different processes are to be executed depending on whether or not external reference data is image data in the processing of the flowchart in FIG. 5;

FIG. 7 is a flowchart for explaining the procedure of processing for acquiring external reference data from a plurality of reference destinations; and

FIG. 8 is a block diagram exemplifying the arrangement for acquiring external reference data from a plurality of reference destinations on the network.

### DESCRIPTION OF THE EMBODIMENTS

Preferred embodiments of the present invention will be exemplarily described in detail hereinafter with reference to the accompanying drawings. Note that building components described in this embodiment are merely examples, and they do not limit the scope of the invention.

### First Embodiment

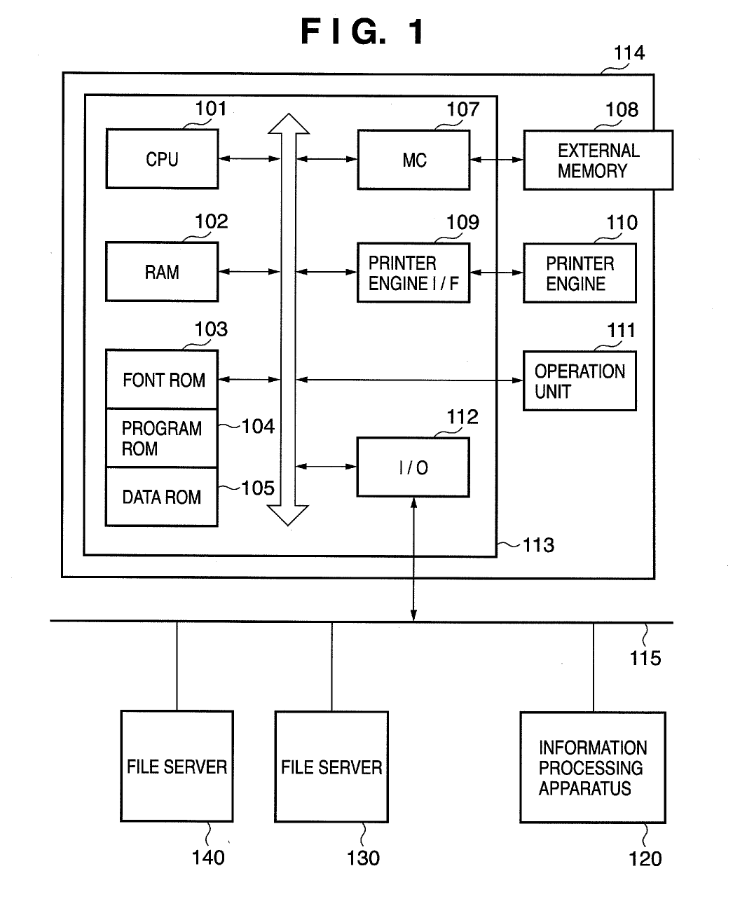

FIG. 1 is a block diagram for explaining the arrangement of a printing apparatus connected to a network. Note that the present invention can be applied to any of a standalone device, a system including a plurality of devices, and a system that implements processing via a network such as a LAN or the like or a wireless LAN, as long as the functions of the present invention can be implemented.

A CPU 101 controls devices connected to a system bus 106 based on control programs and the like stored in a program ROM 104 or those which are stored in an external memory 108 and are loaded onto a RAM 102 when they are launched.

An information processing apparatus 120 can generate structured document data that forms data for each page by embedding, in, for example, an SVG (Scalable Vector Graphics) format, data described in an XML or HTML format.

The CPU 101 can execute, via an I/O 112, communication processing with external devices such as the information processing apparatus 120, file servers 130 and 140, and the like, which are connected to a network 115. Note that communications with the external devices are not limited to those which are made via the network 115. For example, the external devices may be connected via interfaces (not shown) to make communications.

The information processing apparatus 120 can send generated document data (including image data and structured document data) to a printing apparatus or printer 114 via the network 115. The printer 114 receives the document data via the I/O 112, and analyzes the document data under the control of the CPU 101. The CPU 101 can analyze whether or not references to data stored in the external file servers 130, 140, and the like are designated in structured document data, which of file servers 130, 140, and the like is designated as a reference destination, a data reference count, or the like.

The CPU 101 can generate data for each page, which is embedded with data of external reference destinations (file servers 130, 140, and the like) based on the analysis result of the structured document data in, for example, the SVG format or the like. When data must be referred to and acquired from an external reference destination a plurality of times, the CPU 101 can store, in the RAM 102 or external memory 108, data, which is acquired first, in a reusable state. When it is determined based on the data reference count that there is no possibility of reuse of the acquired data, the CPU 101 deletes the externally acquired data or data which is converted for rendering, stored in the RAM 102 or external memory 108.

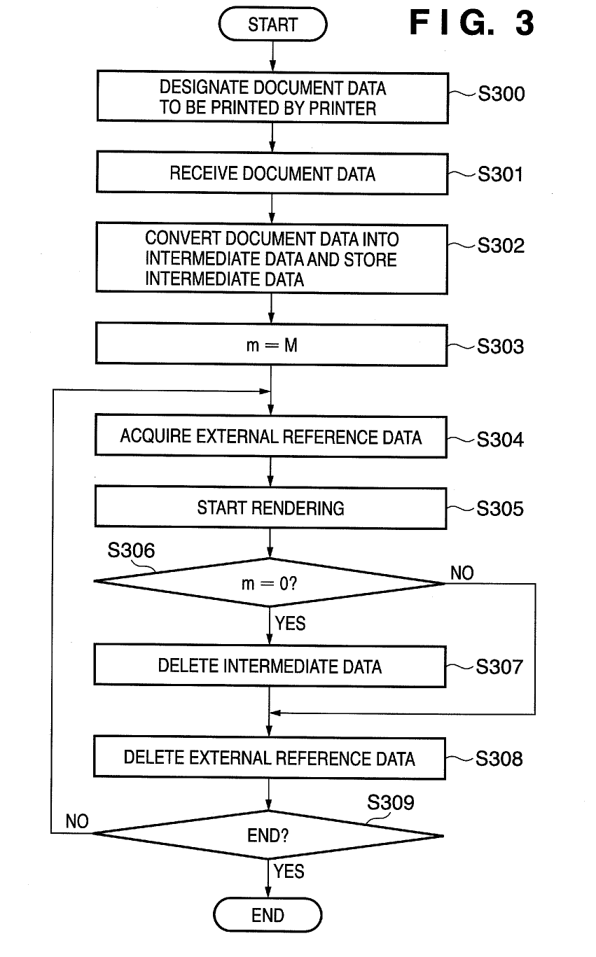

The CPU 101 outputs, as output information, generated data for each page to a printer engine 110 connected via a printer engine I/F 109, and executes print processing. The control programs and the like stored in the program ROM 104 can make the printing apparatus 114 execute processes described in the flowcharts shown in FIGS. 3 to 7 under the control of the CPU 101. Upon execution of the control programs, the printing apparatus 114 can reuse data acquired by external reference, and can delete the data acquired by external reference when it is determined that there is no possibility of reuse. With the processing by the printing apparatus 114, data acquired by external reference can be efficiently processed.

A font ROM 103 of the printing apparatus 114 stores font data and the like used upon generating output information. The RAM 102 serves as a main memory, work area, and the like of the CPU 101, and its memory size can be expanded using an optional RAM connected to an expansion port (not shown). Note that the RAM 102 is also used as a rasterize area of output information, a storage area of environment data, and the like.

A memory controller (MC) 107 controls access to the external memory 108 such as a hard disk or the like, which stores a boot program, various applications, user files, spooled jobs, spooled images, form data, and the like. In addition to the external memory 108, at least one external memory such as a PC card memory or the like may be connected to the MC 107. Also, a plurality of external memories such as an optional font card in addition to built-in font data and an external memory that stores a program for interpreting a printer control language of a different language system may be connected.

An operation unit 111 includes a display panel and keyboard, can provide information to the operator, and can accept inputs of instructions from the operator.

The CPU 101, RAM 102, ROMs 103, 104, and 105, MC 107, printer engine I/F 109, I/O 12, and the like constitute a printer control unit 113.

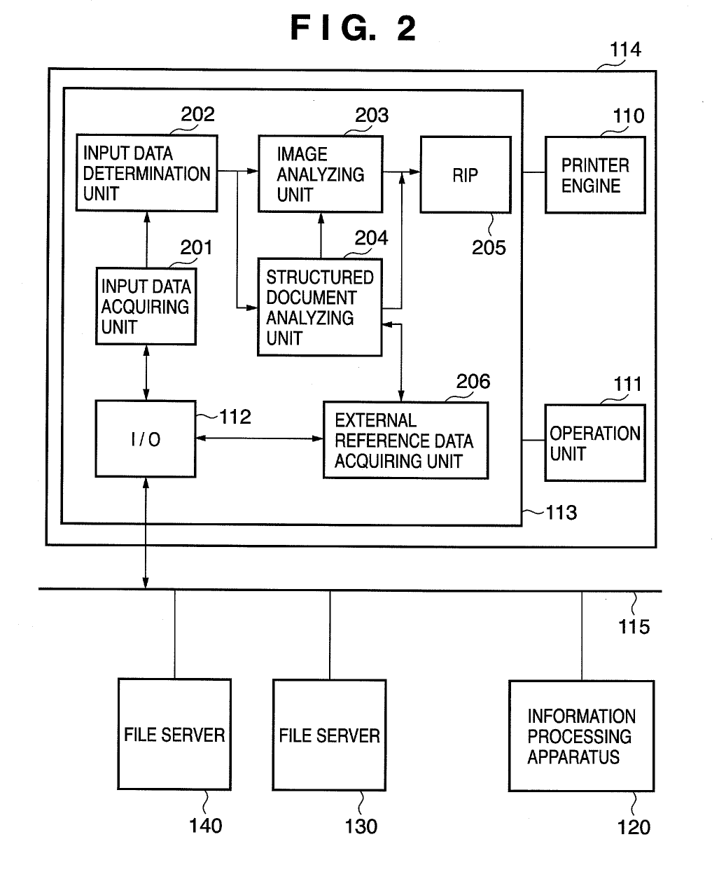

FIG. 2 is a block diagram focused on the functional arrangement of the printer control unit 113. An input data acquiring unit 201 can analyze document data sent from the information processing apparatus 120 via the network 115, interpret a URL included in the document data, and acquire designated data by a protocol designated by the URL. An input data determination unit 202 determines if the data acquired by the input data acquiring unit 201 is structured document data or image data, and distributes the data to a structured data analyzing unit 204 or image analyzing unit 203 based on the determination result.

The image analyzing unit 203 analyzes the format (image format) of the input image data, and generates a display list. The structured document analyzing unit 204 determines a specific format used to describe the input structured document data, makes analysis suited to each of various formats such as PDL, SVG, XML, HTML, and the like, and generates a display list. Upon detection of embedding of data by external reference in the structured document data, the structured document analyzing unit 204 notifies an external reference data acquiring unit 206 (to be described later) of the detected external reference designation (including a URL of a reference destination, data to be referred to, a reference count, and the like). A raster image processing unit (RIP unit) 205 renders the display list generated by the image analyzing unit 203 or structured document analyzing unit 204 to raster image data. The external reference data acquiring unit 206 receives the external reference designation from the structured document analyzing unit 204, and can acquire data at an external reference destination (e.g., the file server 130 or 140) via the I/O 112.

(Basic Operation)

FIG. 3 is a flowchart showing the procedure of basic processing of the printing apparatus 114 according to the embodiment of the present invention. This flowchart is executed under the overall control of the aforementioned printer control unit 113.

In step S300, the user selects document data to be printed using the information processing apparatus 120, a PDA, a mobile terminal, or the like, and sends a print instruction to the printer 114.

In step S301, the input data acquiring unit 201 receives the document data. The input data determination unit 202 determines if the document data received by the input data acquiring unit 201 is image data or structured document data. If the document data is structured document data, it is input to the structured document analyzing unit 204; if the document data is image data, it is input to the image analyzing unit 203.

In step S302, the image analyzing unit 203 or structured document analyzing unit 204 converts object data such as text data, graphic data, and the like in the print data described in a PDL or the like into intermediate data that can undergo rendering more quickly than the PDL data. The intermediate data is stored in the external memory 108 or RAM 102 and is used in rendering processing later.

In step S303, the structured document analyzing unit 204 or the like records an external reference count associated with object data such as text data, graphic data, and the like in the document data. As the external reference count, the number of reference times to an identical reference destination (identical data) is recorded. For example, if there are M data to be acquired from an identical reference destination included in the structured document data (if the identical reference destination is to be repetitively referred to M times), M is set as an initial value in an internal variable m that counts the external reference count. An external reference is expressed, for example, as <A href=“http://.../**.***”></A>, <IMG src=“../**.***”></IMG>, and the like. The reference destination indicates the external reference of the document data and can be obtained via a network or obtained from an apparatus containing the document data. The same reference destination in “ ” indicates reference to the same data.

When data at different reference destinations are to be acquired as object data such as text data, graphic data, and the like, reference counts (for example, m1=M1, m2=M2, . . . ) for respective reference destinations may be recorded, and may be independently managed.

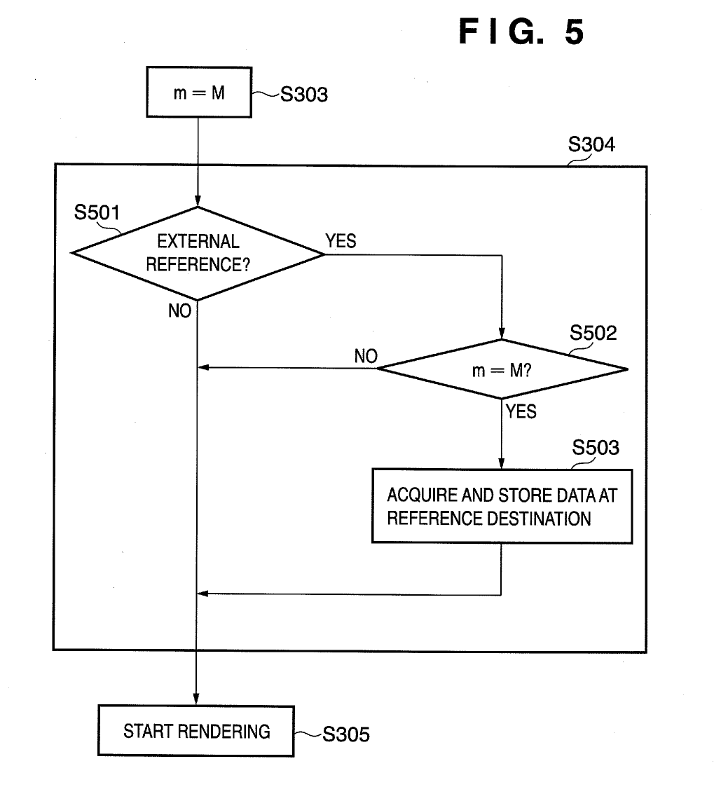

In step S304, the external reference data acquiring unit 206 executes acquisition processing of data (external reference data) from the designated reference destination by external reference. This processing will be described in detail later using the flowcharts of FIGS. 5 to 7, and a description thereof will not be made herein.

In step S305, the raster image processing unit (RIP unit) 205 starts rendering based on the intermediate data converted in step S302 and the external reference data acquired in step S304. If the rendered object data is external reference data, the raster image processing unit (RIP unit) 205 substitutes m−1 in the internal variable m used to manage the reference count. Upon completion of rendering of external reference data once, the internal variable m is decremented by 1 as a reuse count of the external reference data.

The rendering result of the external reference data is stored in the external memory 108, RAM 102, or the like at the completion timing of first rendering (m=M), and can be reused upon subsequent rendering (m=M−1 to 0).

The raster image processing unit (RIP unit) 205 checks in step S306 if the internal variable m used to manage the rendering count of the external reference data is equal to “0”. If m=0 (Yes in step S306), all the M rendering processes of the external reference data are complete. In the subsequent rendering, since the converted intermediate data, the rendering result of the external reference data, and the like are not used, the raster image processing unit (RIP unit) 205 deletes the converted intermediate data and the like (S307).

In step S308, the raster image processing unit (RIP unit) 205 deletes the external reference data acquired in previous step S304.

On the other hand, if m≠0 in step S306, since the intermediate data, the rendering result of the external reference data, and the like are used in the subsequent rendering, the process jumps to step S308 while the intermediate data and the like remain stored.

The raster image processing unit (RIP unit) 205 checks in step S309 if all object data described in the document data have been rendered. If the rendering processing of all the object data is complete (Yes in step S309), the process ends. On the other hand, if the rendering processing of all the object data is not complete yet (No in step S309), the process returns to step S304 to repeat the same processing.

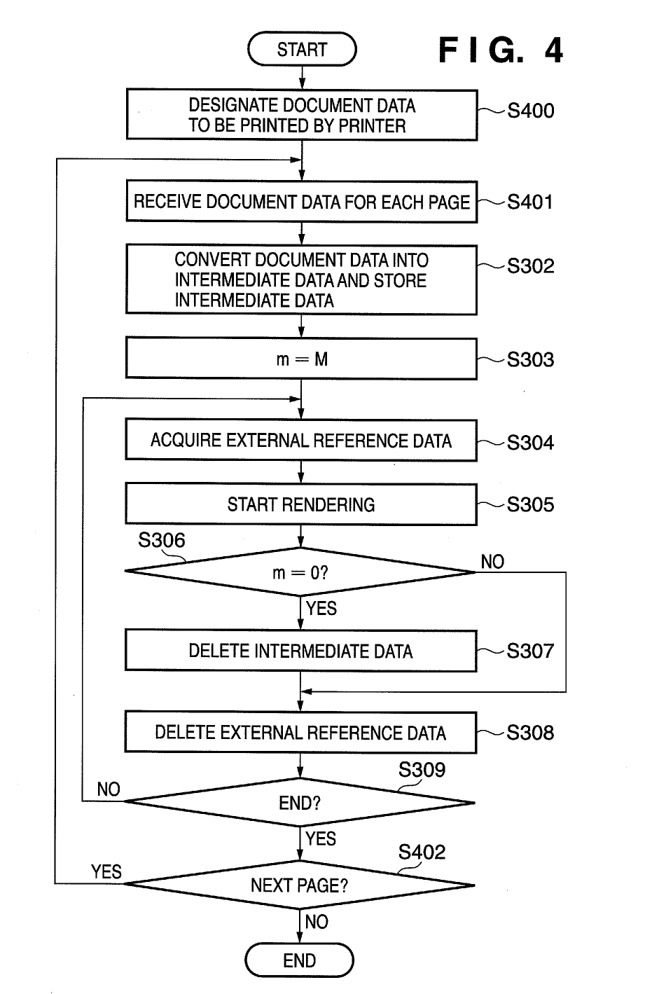

FIG. 4 is a flowchart for explaining the procedure of processing of the printing apparatus 114 when document data input to the printing apparatus 114 according to this embodiment is data including concepts for respective pages. To avoid a repetitive description, the same step numbers denote the same processes as in the flowchart of FIG. 3. This flowchart is executed under the overall control of the printer control unit 113.

In step S400, the user selects document data described in a page description language using the information processing apparatus 120, a PDA, a mobile terminal, or the like, and sends a print instruction to the printer 114.

In step S401, the input data acquiring unit 201 receives the document data described in the page description language.

By the processes in steps S302 to S309, rendering of the document data described in the page description language is executed.

It is checked in step S309 if all object data described in the current page have been rendered. If rendering is complete (Yes in step S309), the process advances to step S402. On the other hand, if it is determined in step S309 that rendering is not complete yet (No in step S309), the process returns to step S304 to execute the same processes in step S304 and subsequent steps.

If all the object data described in the current page have been rendered, it is checked in step S402 if the document data includes the next page after the current page. If the next page is included (Yes in step S402), the process returns to step S401, and the input data acquiring unit 201 receives document data of the next page, thus repeating the same processing. If the rendering processing of all the pages is complete (No in step S402), the process ends.

(Acquisition Processing of External Reference Data)

The practical procedure of the acquisition processing (S304) of external reference data in FIGS. 3 and 4 will be described below with reference to FIGS. 5 to 7. The flowcharts of FIGS. 5 to 7 are executed under the overall control of the aforementioned printer control unit 113.

Assume that the reference count of external reference data at an identical reference destination included in the document data is set to be m=M (S303).

It is checked in step S501 if object data described in the document data to be rendered is data to be acquired by external reference. If it is determined in step S501 that the object data is data to be acquired by external reference (Yes in step S501), the process advances to step S502.

On the other hand, if the object data need not be acquired by external reference (No in step S501), the raster image processing unit (RIP unit) 205 starts rendering (S305).

In step S502, the internal variable m is compared with the external reference count M. If m=M (Yes in step S502), the process advances to step S503. In step S503, the external reference data acquiring unit 206 acquires external reference data corresponding to object data described in the document data from the reference destination, and stores the acquired data in the external memory 108 or RAM 102.

Note that the external reference data acquiring unit 206 can acquire external reference data by the designated protocol from the reference destination (e.g., URL) of the external reference data. For example, when the file server 130 or 140 on the network 115 is designated as the reference destination, XML data and HTML data stored in the file server 130 or 140 can be acquired as external reference data. The external reference data is stored in the external memory 108 or RAM 102, and is used in rendering processing later.

On the other hand, if the internal variable m is not equal to the external reference count M (No in step S502), since the external reference data at the reference destination has already been acquired when m=M was determined, the same reference destination (acquisition of the same data) need not be followed. In this case, the raster image processing unit (RIP unit) 205 reuses the rendering result of the external reference data stored at the completion timing of first rendering (m=M) in step S305. The raster image processing unit (RIP unit) 205 sets m−1 in the internal variable m.

With this processing, the rendering result of the external reference data can be reused without redundantly acquiring external reference data from the same reference destination, thus efficiently processing the document data.

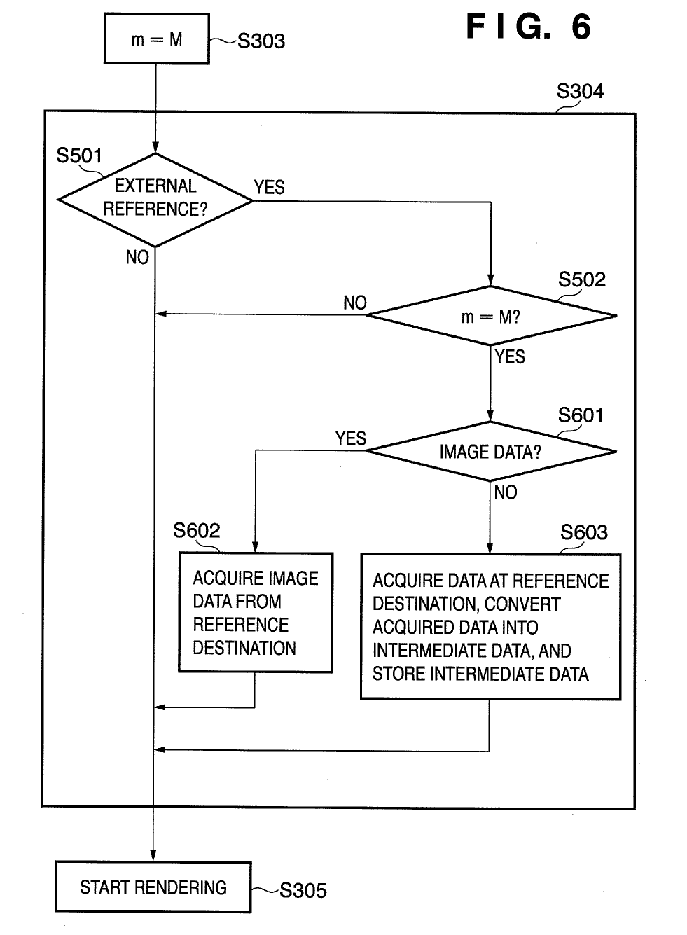

FIG. 6 is a flowchart for explaining an example when different processes are to be executed depending on whether or not external reference data is image data in the processing of the flowchart in FIG. 5. To avoid a repetitive description, the same step numbers denote the same processes as in the flowchart of FIG. 5.

If it is determined in step S601 that data to be acquired by external reference is image data, the process advances to step S602, and the external reference data acquiring unit 206 acquires image data from the reference destination. At this time, if image data at the reference destination cannot be acquired due to the remaining capacity of the external memory 108 or the like, the external reference data acquiring unit 206 can notify the print instruction source side (information processing apparatus 120 or the like) that the external reference data cannot be acquired.

In step S305, the raster image processing unit (RIP unit) 205 executes rendering processing based on the acquired image data, and sets m−1 in the internal variable m.

On the other hand, if it is determined in step S601 that the document to be acquired by external reference is document data (No in step S601), the external reference data acquiring unit 206 acquires document data at the reference destination. The structured document analyzing unit 204 analyzes the acquired document data to convert it into intermediate data, and stores the intermediate data (S603).

The intermediate data converted in step S603 can be stored in combination with that converted in step S302 in FIG. 3. The raster image processing unit (RIP unit) 205 executes rendering based on the converted intermediate data and sets m−1 in the internal variable m (S305).

If data at the reference destination is neither image data nor document data, the external reference data acquiring unit 206 can notify the print instruction source side (information processing apparatus 120 or the like) of this.

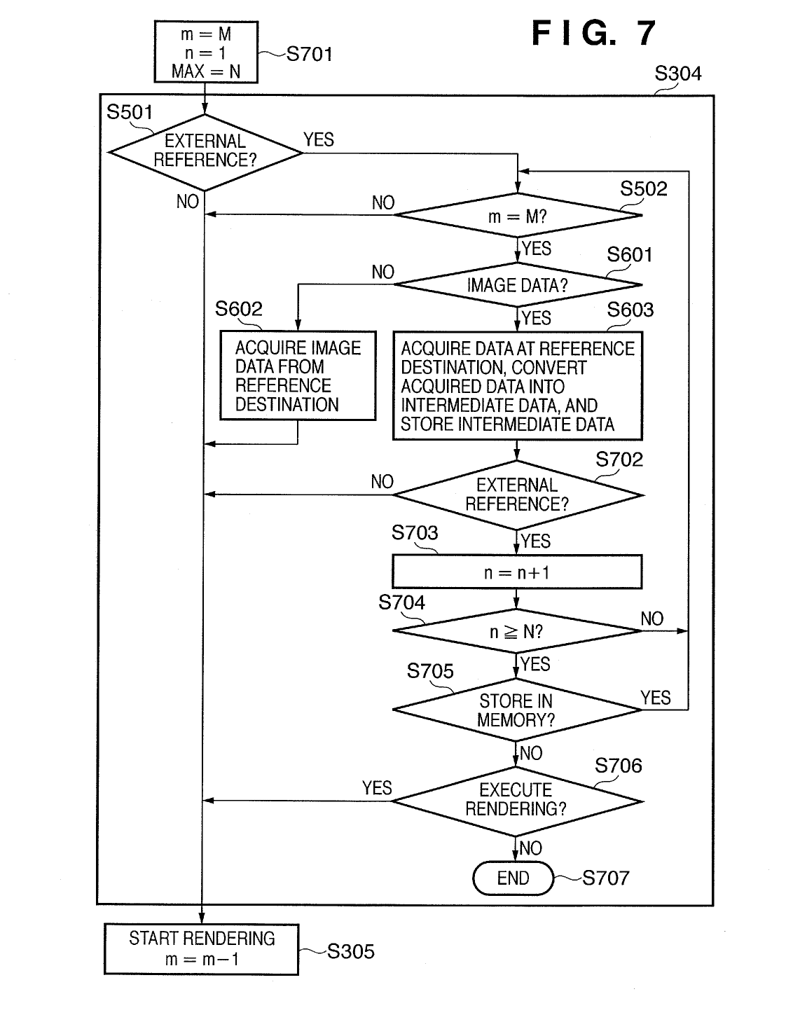

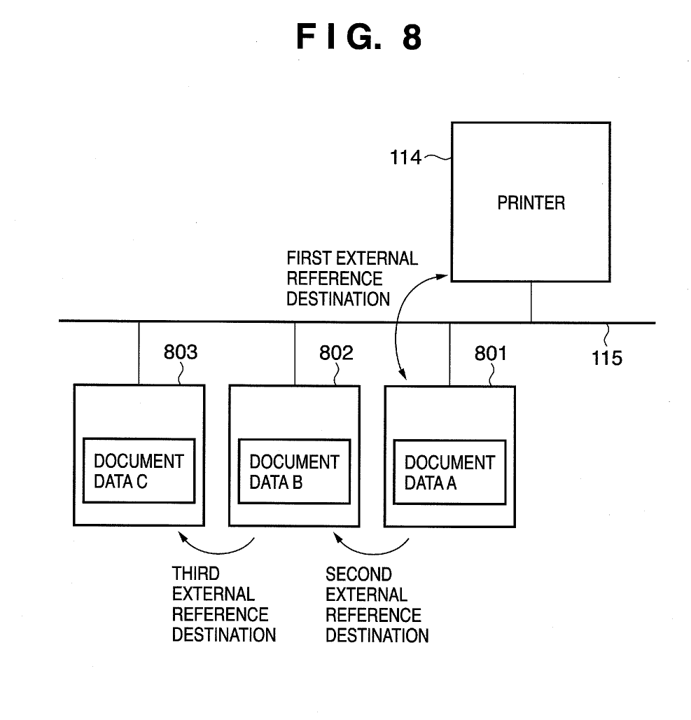

An example of acquiring external reference data from a plurality of reference destinations will be described below with reference to the flowchart of FIG. 7, and FIG. 8.

FIG. 8 is a block diagram exemplifying the arrangement for acquiring external reference data from a plurality of reference destinations on the network 115. Assume that file servers 801, 802, and 803 respectively store document data A, B, and C. The file servers 801, 802, and 803 can communicate with each other via the network 115. The file servers 801, 802, and 803 can also communicate with the printer 114 via the network 115.

The external reference data acquiring unit 206 of the printer 114 acquires document data A as external reference data from the file server 801 as a first external reference destination. At this time, when document data A designates, as a second external reference destination, document data B stored in the file server 802 as external reference data, the external reference data acquiring unit 206 can acquire document data B as external reference data. Furthermore, when document data B designates, as a third reference destination, document data C stored in the file server 803 as external reference data, the external reference data acquiring unit 206 can acquire data C as external reference data.

As the number of layers of external reference, external reference from the printer 114 to the file server 801 has the number of layers=1, that to the file server 802 has the number of layers=2, and that to the file server 803 has the number of layers=3.

FIG. 7 is a flowchart for explaining the procedure of processing for acquiring external reference data from a plurality of destinations. To avoid a repetitive description, the same step numbers in the flowchart of FIG. 7 denote the same processes as in the flowchart of FIG. 6.

In step S701, assume that the reference count of external reference data at the same reference destination included in document data is set to be m=M. Let n be an internal variable used to manage the number of layers of external reference, and “1” is set as its initial value. Also, assume that MAX=N is set as the upper limit of the number of layers. The external reference data acquiring unit 206 can control acquisition of external reference data based on the number of layers of external reference.

Steps S501, S502, and S601 to S603 are the same processes as those in FIG. 6.

The structured document analyzing unit 204 checks in step S702 if the external reference data acquired by the external reference data acquiring unit 206 in step S603 includes that stored at another external reference destination. The structured document analyzing unit 204 notifies the external reference data acquiring unit 206 of the other determined external reference destination. Based on this notification, the external reference data acquiring unit 206 can acquire external reference data stored at the other external reference destination.

If it is determined in step S702 that there is no external reference data stored at another external reference destination (No in step S702), the process advances to step S305. The raster image processing unit (RIP unit) 205 executes rendering processing, and sets m−1 in the internal variable m (S305).

On the other hand, if it is determined in step S702 that there is external reference data stored at another external reference destination (Yes in step S702), the external reference data acquiring unit 206 increments the internal variable n used to manage the number of layers of external reference by 1 in step S703.

In step S704, the external reference data acquiring unit 206 compares the internal variable n used to manage the number of layers of external reference with the upper limit N. If n<N in step S704 (No in step S704), the process returns to step S502 to repeat the same processing.

If n≧N in step S704 (Yes in step S704), the process advances to step S705, and the external reference data acquiring unit 206 confirms the free memory size of the external memory 108, RAM 102, or the like. If the external reference data acquiring unit 206 determines that the memory (external memory 108, RAM 102, or the like) can store external reference data (Yes in step S705), the process returns to step S502 to repeat the same processing. On the other hand, if the external reference data acquiring unit 206 determines in step S705 that the memory cannot store external reference data (No in step S705), the process advances to step S706.

In step S706, the external reference data acquiring unit 206 notifies the print instruction source (information processing apparatus 120 or the like) that all external reference data cannot be acquired, and sends an inquiry about whether or not to execute rendering to the print instruction source.

If rendering is to be executed (Yes in step S706), the process advances to step S305. In step S305, the raster image processing unit (RIP unit) 205 executes rendering processing using external reference data that can be acquired, and sets m−1 in the internal variable m.

On the other hand, if it is determined in step S707 that rendering is aborted, the process advances to step S707. In step S707, the intermediate data and external reference data are deleted, and the process ends.

Upon acquiring external reference data from a plurality of reference destinations, the upper limit of the number of layers of external reference is set, and execution of external acquisition and rendering can be controlled based on the relationship with the free memory area size.

According to the embodiment of the present invention, document data including an external reference can be efficiently processed.

### Other Embodiments

Note that the objects of the present invention are also achieved by supplying a storage medium, which records a program code of software that can implement the functions of the above-mentioned embodiments to a system or apparatus. Also, the objects can be achieved when a computer (or a CPU or MPU) of the system or apparatus reads out and executes the program code stored in the storage medium.

In this case, the program code itself read out from the storage medium implements the functions of the aforementioned embodiments, and the storage medium which stores the program code constitutes the present invention.

As the storage medium for supplying the program code, for example, a flexible disk, hard disk, optical disk, magneto-optical disk, CD-ROM, CD-R, nonvolatile memory card, RON, and the like may be used.

The functions of the above-mentioned embodiments are implemented when the computer executes the readout program code. Also, an OS (operating system) running on the computer executes some or all of actual processing operations based on an instruction of the program code to implement the above-mentioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-168115, filed Jun. 16, 2006, which is hereby incorporated by reference herein in its entirety.

What is claimed is:

1. A printing apparatus comprising:
an analyzing unit adapted to analyze, from document data received via a network, a reference count of each of external reference data to be acquired from a reference destination on the network;
an acquiring unit adapted to acquire the external reference data from the reference destination on the network based on the analysis result of said analyzing unit;
an interpreting unit adapted to interpret the external reference data acquired by said acquiring unit;
a storage unit adapted to store the data interpreted by said interpreting unit in a reusable state; and
a management unit adapted to manage storage of the interpreted data in said storage unit based on the reference count.

2. The apparatus according to claim 1, further comprising:
an intermediate data conversion unit adapted to convert the document data into intermediate data for print processing; and
a data determination unit adapted to determine if the external reference data is image data or document data,
wherein when said data determination unit determines that the external reference data is document data, said intermediate data conversion unit converts the external reference data into the intermediate data.

3. The apparatus according to claim 2, wherein said storage unit stores, in a reusable state, the intermediate data which is converted from the external reference data by said intermediate data conversion unit.

4. The apparatus according to claim 1, wherein said analyzing unit analyzes if the external reference data includes the presence/absence of external reference data to be acquired from another reference destination on the network, and
when there is external reference data to be acquired from the other reference destination based on the analysis result of said analyzing unit, said acquiring unit controls acquisition of the external reference data based on the number of layers of external reference.

5. The apparatus according to claim 1, wherein when the reference count is equal to a reuse count of the external reference data, said management unit determines that the data stored in said storage unit is not reused, and deletes the data which is obtained by interpreting the external reference data and is stored in the reusable state.

6. A printing control method comprising steps of:
analyzing, from document data received via a network, a reference count of each of external reference data to be acquired from a reference destination on the network;
acquiring the external reference data from the reference destination on the network based on the analysis result in the analyzing step;
interpreting the external reference data acquired in the acquiring step;
storing, in a storage unit, the external reference data interpreted in the interpreting step in a reusable state; and
managing storage of the interpreted data in the storage unit based on the reference count.

7. The method according to claim 6, further comprising the steps of:
converting the document data into intermediate data for print processing; and
determining if the external reference data is image data or document data,
wherein when it is determined in the data determining step that the external reference data is document data, the external reference data is converted into the intermediate data in the intermediate data converting step.

8. The method according to claim 7, wherein in the storing step, the intermediate data which is converted from the external reference data in the intermediate data converting step is stored in the storage unit in a reusable state.

9. The method according to claim 6, wherein in the analyzing step, it is analyzed if the external reference data includes the presence/absence of external reference data to be acquired from another reference destination on the network, and
when there is external reference data to be acquired from the other reference destination based on the analysis result in the analyzing step, acquisition of the external reference data is controlled based on the number of layers of external reference in the acquiring step.

10. The method according to claim 6, wherein when the reference count is equal to a reuse count of the external reference data, it is determined in the reuse determining step that the external reference data stored in the storing step is not reused, and
in the managing step, the external reference data stored in the reusable state is deleted based on the determination result in the reuse determining step.

11. A program, stored in a computer-readable storage medium, for making a computer execute a print control method according to claim 6.

12. A computer-readable storage medium storing a program according to claim 11.
